(19) United States
(12) Patent Application Publication
(10) Pub. No.: US 2025/0089733 A1
(43) Pub. Date: Mar. 20, 2025

(54) A NON-DAIRY CREAMER COMPOSITION AND A METHOD FOR PREPARING THE SAME

(71) Applicant: CARGILL, INCORPORATED, Wayzata, MN (US)

(72) Inventors: Yun GE, Nantong (CN); Guifang CHANG, Shanghai (CN); Yaobin SI, Shanghai (CN)

(21) Appl. No.: 18/729,343

(22) PCT Filed: Jan. 17, 2023
(86) PCT No.: PCT/US2023/060732

§ 371 Date: Jul. 16, 2024

(30) Foreign Application Priority Data
Jan. 17, 2022 (WO) PCT/CN2022/072266

(51) Int. Cl. A23D 9/007; A23C 11/08; A23D 9/04; A23L 2/60

(52) U.S. Cl. CPC A23D 9/007; A23C 11/08; A23D 9/04; A23L 2/60

(57) ABSTRACT

The present invention relates to a non-dairy creamer and the triglyceride composition including a first ingredient, a second ingredient and a third ingredient. The first ingredient and the second ingredient together are from about 65wt % to about 80wt % by the weight of the triglyceride composition, and the third ingredient is from about 20wt % to about 35wt % by weight of the triglyceride composition. The first ingredient, the second ingredient and the third ingredient each have a MCPD content of less than 2500 ppb and a GE content of less than 1000 ppb. The first ingredient and the second ingredient are different, and the first ingredient and second ingredient are each selected from the group consisting of palm oil, palm kernel oil, palm kernel olein, palm kernel stearin, palm stearin, palm super stearin, palm olein, palm super olein, palm mid-fraction and a combination thereof. The third ingredient includes a lauric triglyceride.

### CROSS-REFERENCE TO RELATED APPLICATION

This application claims the benefit of PCT Application No. PCT/CN2022/072266, filed Jan. 17, 2022, which is incorporated by reference herein in its entirety.

### FIELD OF THE INVENTION

The present invention generally relates to the technical field of non-dairy creamers.

### BACKGROUND OF THE INVENTION

Non-dairy creamers, also referred to as beverage whiteners, are milk or cream substitutes added to beverages such as coffee, tea and hot chocolate. Non-dairy creamers come in both liquid and granular forms.

Quite often, non-dairy creamers use hydrogenated oils as base oils. Hydrogenated oils not only provide good texture and mouthfeel, but also deliver a long lasting, shelf-stable special flavor. The special flavor of hydrogenated oils is referred to as hydrogenated flavor, which some people would describe as dairy-like and associate with sweet pastries.

However, hydrogenated oils, when only partially hydrogenated, contain trans fats. Taking hydrogenated soybean oil as an example, hydrogenated soybean oil is conventionally used as a base oil for non-dairy creamers, and may have a trans fatty acid content of 40% or more.

Trans fats raise the of low-density lipoprotein (known as the “bad cholesterol”) level and lower the high-density lipoprotein (known as the “good cholesterol”) level, and thus contribute to higher risks of heart attacks, heart disease, etc. Trans fats have also been associated with the development of type 2 diabetes.

Specific compounds contributing to the peculiar flavor of hydrogenated soybean oil have been identified, such that suitable substitutes therefor can be developed. For instance, in “Identification of Volatile Flavor Compounds Developed during Storage of a Deodorized Hydrogenated Soybean oil” (Yasuda, et al., J Am Oil Chem Soc (1975) 52:307. https://doi.org/10.1007/BF02637732), Yasuda, et al. reported the separation and identification of volatile compounds that appear to contribute to the flavor of hydrogenated soybean oil. However, this paper does not address the issue of substitutes for hydrogenated soybean oil.

PCT application WO 2013/027439 A1 entitled “Oxidized partially hydrogenated oil” by Hanajiri, et al. and published on 28 Feb. 2013 discloses an oil or fat composition with reduced trans-fatty acid content. The claimed oil or fat composition is produced by oxidizing a partially hydrogenated oil or fat until its peroxide value reaches a certain threshold.

Palm oil is the oil extracted from the fruit of the oil palm trees. Palm oil has approximately 50% saturated fatty acids and 50% unsaturated fatty acids. Due to such a unique fatty acid profile, palm oil is oxidatively stable and easy to formulate with. As such, palm oil finds its applications in various technical fields, from food and personal-care products to biofuel.

Palm oil has also been used in the technical field of non-dairy creamers. For instance, it has been added to non-dairy creamers, for instance, to replace hydrogenated oils for trans fat reduction. However, the mouthfeel and flavor of palm oil is incomparable to hydrogenated oils, and its use in the field of non-dairy creamers is thus limited.

As such, there is a need in the food industry for palm oil-based compositions of non-dairy creamers that can provide equally good mouth feel and flavor as hydrogenated oils, such as hydrogenated soybean oil.

### SUMMARY OF THE INVENTION

An aspect of the present invention relates to a triglyceride composition. The triglyceride composition includes a first ingredient, a second ingredient and a third ingredient. The first ingredient and the second ingredient together are from about 65 wt % to about 80 wt % by the weight of the triglyceride composition, and the third ingredient is from about 20 wt % to about 35 wt % by weight of the triglyceride composition. The first ingredient, the second ingredient and the third ingredient each have a MCPD content of less than 2500 ppb and a GE content of less than 1000 ppb. The first ingredient and the second ingredient are different, and the first ingredient and second ingredient are each selected from the group consisting of palm oil, palm kernel oil, palm kernel olein, palm kernel stearin, palm stearin, palm super stearin, palm olein, palm super olein, palm mid-fraction and a combination thereof. The third ingredient includes a lauric triglyceride.

Another aspect of the present invention relates to a non-dairy creamer including a triglyceride composition according to the present invention.

A further aspect of the present invention relates to use of a triglyceride composition according to the present invention to improve a sensory property of a beverage, the sensory property being selected from the group consisting of flavor, aroma, mouthfeel and a combination thereof.

A yet further aspect of the present invention relates to a beverage including the triglyceride composition according to the present invention or the non-dairy creamer of the present invention, the beverage being selected from the group consisting of tea, coffee, chocolate drink, milkshake, smoothie, cocktail and a combination thereof.

A yet further aspect of the present invention relates to a method for preparing a triglyceride composition for use as a non-dairy creamer of a beverage, including: providing a first ingredient, wherein the first ingredient is palm oil or palm oil derivative having a MCPD content of less than 2500 ppb and a GE content of less than 1000 ppb; providing a second ingredient, wherein the second ingredient is palm oil or palm oil derivative having a MCPD content of less than 2500 ppb and a GE content of less than 1000 ppb; providing a third ingredient, wherein the third ingredient comprises lauric triglyceride and has a MCPD content of less than 2500 ppb and a GE content of less than 1000 ppb; and mixing the first ingredient, the second ingredient with the third ingredient to provide the triglyceride composition. The first ingredient and the second ingredient together are from about 65 wt % to about 80 wt % by the weight of the triglyceride composition, and the third ingredient is from about 20 wt % to about 35 wt % by weight of the triglyceride composition. The first ingredient and the second ingredient are different, and the first ingredient and second ingredient are each selected from the group consisting of palm oil, palm kernel oil, palm kernel olein, palm kernel stearin, palm stearin, palm super stearin, palm olein, palm super olein, palm mid-fraction and a combination thereof.

### DETAILED DESCRIPTION OF THE INVENTION

Unless otherwise noted, all measurements, weights, lengths etc. are in metric units, and all temperatures are in degrees Celsius. It is understood that unless otherwise specifically noted, the materials compounds, chemicals, etc. described herein are typically commodity items and/or industry-standard items available from a variety of suppliers and sources worldwide.

As used herein, the term “triglyceride composition” refers to a composition the main components of which are one or more triglycerides. A triglyceride may be an oil or a fat, derived from various sources including plants, animals and microorganisms.

As used herein, the term “oil” refers to an oil individually or a blend of two or more different oils. By the same token, the term “fat” refers to a fat individually or a blend of two or more fats.

As used herein, the term “lauric triglyceride” refers to a triglyceride that is rich in saturated fatty acids with a carbon chain length of 12 and 14 (C12 and C14) and is not hydrogenated (fully or partially). Examples of lauric fat are, but are not limited to, coconut oil, palm kernel oil, palm kernel stearin, palm kernel olein, or a mixture of two or more thereof.

As used herein, the term “low contaminants” refers to a contaminant level with the 3-MCPD content being less than 2500 ppb and the GE content being less than 1000 ppb.

As used herein, the expression “CX:Y” refers to a lipid number, with X standing for the number of carbon atoms in the fatty acid chain and Y standing for the number of double bonds in the fatty acid chain.

An aspect of the present invention relates to a triglyceride composition. The triglyceride composition includes a first ingredient, a second ingredient and a third ingredient. The first ingredient and the second ingredient together are from about 65 wt % to about 80 wt % by the weight of the triglyceride composition, and the third ingredient is from about 20 wt % to about 35 wt % by weight of the triglyceride composition. The first ingredient, the second ingredient and the third ingredient each have a 3-MCPD content of less than 2500 ppb and a GE content of less than 1000 ppb. The first ingredient and the second ingredient are different, and the first ingredient and second ingredient are each selected from the group consisting of palm oil, palm kernel oil, palm kernel olein, palm kernel stearin, palm stearin, palm super stearin, palm olein, palm super olein, palm mid-fraction and a combination thereof. The third ingredient includes a lauric triglyceride.

The inventors have also discovered that, an improved mouthfeel (i.e., simulation of the mouthfeel of a hydrogenated oil) improved flavor may be achieved by blending the palm oil and/or palm oil derivative of low 3-MCPD ester and GE content with a lauric triglyceride. Improved mouthfeel may refer to increased richness and/or increased smoothness. Improved flavor may refer to increased pleasant flavor, increased milky flavor, and/or the increase in any other flavor an average consumer may associate with a dairy product or a sweet pastry. Improved flavor may also refer to a flavor profile in which the pleasant and/or milky flavor are prominent to an average consumer.

Without intending to be bound by theory, it is believed that a synergistic effect between the improved mouthfeel and the improved flavor is achieved, in that they in conjunction better simulate the sensory profile of a hydrogenated oil (e.g., hydrogenated soybean oil) when used as a non-dairy creamer. As such, the compositions of the present invention using lauric triglyceride and palm oil or a derivative thereof each with low contaminants is believed to be particularly advantageous as a substitute for hydrogenated oils in non-dairy creamers.

In an aspect, the first ingredient, the second ingredient and the third ingredient each have a MCPD content of less than 1500 ppb and a GE content of less than 500 ppb.

Different methods may be used to reduce the level of 3-MCPD esters and GEs in palm oil or a derivative thereof. One method is to control the refining process of the palm oil or its derivative.

The refining process typically consists of three major steps: degumming, bleaching and deodorizing. An oil obtained after completion of the refining process (called a “refined oil” or more specifically a deodorized oil) is normally considered suitable for human consumption and may therefore be used in the production of any number of foods and beverages. However, the refining process itself may contribute to the introduction, into the refined oil, of high levels of 3-monochloropropane-1,2-diol fatty acid esters (3-MCPD esters), 2-chloro-1,3-propanediol fatty acid esters (2-MCPD esters) and glycidyl esters (GE), by exposing the oils to high temperatures during processing, in particular during deodorization. As such, it is possible to reduce the content of 3-MCPD esters and GE in refined palm oil or a refined palm oil derivative by controlling the refining process. PCT application WO 2020/197770 A1 by Cargill, published on 1 Oct. 2020, describes a refining process which produces refined palm oil or derivatives having a substantially reduced content of 3-MCPD and GE than conventional palm oil or derivative. Its disclosure is incorporated by reference into the present application.

Moreover, the content of 3-MCPD and GE may also be reduced through other techniques. For instance, Kemeny et. al. found that the content of MCPE esters and GE may be controlled during the plantation and crush process (“MCPDE and GE: An Update on Mitigation Measures”, Zsolt Kemeny et. al., Encyclopedia of Food Chemistry, 2019, 578-587). Gibon et. al. found that the formation of 3-MCPD and GE can be mitigated by modifying the refining process such as the interesterification step (“Oil modification: solution or problem for 3-monochlorol-1,3-propanediol(3-MCPD) and glycidyl esters(GE) mitigation?”, Véronique Gibon et. al., INFORM, March 2018, Vol. 29(3)). The disclosure of these papers is also incorporated by reference herein.

In another aspect, the first and second ingredients together are from 68 wt % to about 78 wt %, by weight of the triglyceride composition; or from about 70 wt % to about 75 wt %, by weight of the triglyceride composition. In a further aspect, the third ingredient is from about 23 wt % to about 33 wt %, by weight of the triglyceride composition; or from about 25 wt % to about 30 wt %, by weight of the triglyceride composition.

As noted above, it is believed that the incorporation of the third ingredient into the composition brings about an unexpected synergistic effect, in that it improves the mouthfeel and texture of the composition, which in turn improves the flavor and aroma thereof.

In a yet further aspect, the triglyceride composition of the present invention has a lauric acid content of 8 wt % to about 25 wt %, or from about 10% to about 25 wt %, or from about 10.5 wt % to about 20 wt %, or from about 11 wt % to about 15 wt %, by weight of the total fatty acid content; a palm acid content of from about 20 wt % to about 60 wt %, or from about 25 wt % to about 55 wt %, or from about 30 wt % to about 40 wt %, by weight of the total fatty acid content; and a stearic acid content of from about 3 wt % to about 15 wt %, or from about 3 wt % to about 10 wt %, from about 3.3 wt % to about 6 wt %, or of from about 3.5 wt % to about 5.5 wt %, by weight of the total fatty acid content. Without intending to be bound by theory, it is believed that the specific fatty acid profile of the composition contributes to a melting point close to that of a hydrogenated oil, thereby simulating the mouthfeel and texture thereof.

In an aspect, the ratio of the first ingredient to the second ingredient in the composition is from about 3 to about 6; or from about 3.1 to about 5.9; or from about 3.2 to about 5.7. Without intending to be bound by theory, it is believed that the specific ratio between the first and second ingredients also contribute to a melting point close to that of a hydrogenated oil, thereby simulating the mouthfeel and texture thereof.

In another aspect, the first and second ingredients are each selected from the group consisting of palm olein, palm stearin and a combination thereof, the first ingredient being different from the second ingredient; or the first ingredient is palm olein, and the second ingredient is palm stearin. It should be understood that, to the extent that the 3-MCPD ester and GE content therein is low and the melting point of the composition is close to that of a hydrogenated oil, a person skilled in the art may select other palm oil fractions to be used as the first and second ingredients for the composition.

In a yet further aspect, the third ingredient is selected from the group consisting of palm kernel oil, palm kernel olein, palm kernel stearin, coconut oil, palm kernel olein and a combination thereof; or is palm kernel olein.

The present invention relates to a non-dairy creamer including a triglyceride composition according to the present invention.

In an aspect, the non-dairy creamer may additionally include an ingredient selected from the group consisting of a sweetening substance, an antioxidant, a filler, a protein strengthener, a flavoring substance, a pigment, a flavor/mouthfeel enhancer, a thickening, gelling, stabilizing or emulsifying agent, a health boosting ingredient, a solvent and a combination thereof.

For instance, the sweetening substance may be selected from the group consisting of a sugar, a sugar substitute, and a combination thereof; or selected from the group consisting of acesulfame potassium, alitame, aspartame, cyclamate, saccharin, sucralose, thaumatin, neotame, sucrose, fructose, isomalt, lactitol, mannitol, maltitol, xylitol, sorbitol, steviol glycoside and a combination thereof. In another example, the flavoring substance may be selected from the group consisting of a vanilla extract, vanillin, a banana flavoring oil or extract, almond flavoring oil or extract, coconut flavoring oil or extract, coffee flavoring oil or extract, hazelnut flavoring oil or extract, cinnamon flavoring oil or extract, tea flavoring oil or extract, pecan flavoring oil or extract, caramel flavoring or extract, turmeric flavoring or extract, soy flavoring or extract and a combination thereof. It should be appreciated that a person skilled in the art may determine what additional ingredient or ingredients to be added to the composition, depending on factors such as preferences of target consumers of the composition.

In an aspect, the non-dairy creamer is comprising the triglyceride composition according to the present invention in an amount of 20 wt. % to 100 wt. %, preferably 30 wt. % to 90 wt. %. The triglyceride composition according to the present invention is present in an amount of at least 25 wt. % up to 100 wt. %, at least 30 wt. %, at least 40 wt. %, at least 45 wt. % and up to 80 wt. %, up to 85 wt. %, up to 95 wt. %. The triglyceride composition according to the present invention is present in an amount of from 25 wt. % up to 35 wt. %. The triglyceride composition according to the present invention is present in an amount of from 75 wt. % to 100 wt. %. Each time the wt. % is based upon the total weight of the non-dairy creamer.

In an aspect, the non-dairy is further comprising the sweetening substance in an amount of from 0 to 78 wt. %, preferably 60 to 70 wt % The sweetening substance is present in an amount of 63 wt % to 75 wt. %. Each time the wt. % is based upon the total weight of the non-dairy creamer.

A further aspect of the present invention relates to use of a triglyceride composition according to the present invention to improve a sensory property of a beverage, the sensory property being selected from the group consisting of flavor, aroma, mouthfeel and a combination thereof.

In an aspect, the beverage is selected from the group consisting of tea, coffee, hot chocolate, milkshake, smoothie, cocktail and a combination thereof. In another aspect, the triglyceride composition is used as a non-dairy creamer. In a further aspect, the triglyceride composition simulates the sensory property of hydrogenated coconut oil, partially hydrogenated soybean oil and/or hydrogenated palm kernel oil.

A yet further aspect of the present invention relates to a beverage including the triglyceride composition according to the present invention, the beverage being selected from the group consisting of tea, coffee, chocolate drink, milkshake, smoothie, cocktail and a combination thereof.

A yet further aspect of the present invention relates to a method for preparing a triglyceride composition for use as a non-dairy creamer of a beverage, including: providing a first ingredient, wherein the first ingredient is palm oil or palm oil derivative having a MCPD content of less than 2500 ppb and a GE content of less than 1000 ppb; providing a second ingredient, wherein the second ingredient is palm oil or palm oil derivative having a MCPD content of less than 2500 ppb and a GE content of less than 1000 ppb; providing a third ingredient, wherein the third ingredient comprises lauric triglyceride and has a MCPD content of less than 2500 ppb and a GE content of less than 1000 ppb; and mixing the first ingredient, the second ingredient with the third ingredient to provide the triglyceride composition. The first ingredient and the second ingredient together are from about 65 wt % to about 80 wt % by the weight of the triglyceride composition, and the third ingredient is from about 20 wt % to about 35 wt % by weight of the triglyceride composition. The first ingredient and the second ingredient are different, and the first ingredient and second ingredient are each selected from the group consisting of palm oil, palm kernel oil, palm kernel olein, palm kernel stearin, palm stearin, palm super stearin, palm olein, palm super olein, palm mid-fraction and a combination thereof.

The present invention is now further described with reference to examples.

### EXEMPLARY REFINING PROCESS

Described herein is an exemplary process for manufacturing a refined vegetable oil having a reduced content of 3-MCPD esters and GE, characterized in that it includes the following steps:
a) Treating a deodorized vegetable oil with a base in a continuous pipe reactor, b) Contacting the base treated oil with an adsorbent and/or an acid.

The deodorized vegetable oil in step a) of the process in the context of the present invention is used in the preparation of the ingredient and/or ingredients used in the present invention, preferably it is palm oil or a palm oil derivative. Specifically, the deodorized vegetable oil may be palm oil, palm kernel oil, palm kernel olein, palm kernel stearin, palm stearin, palm super stearin, palm olein, palm super olein and/or palm mid-fraction.

Typically, a deodorized vegetable edible oil may be obtained by means of 2 major types of refining processes, i.e. a chemical or a physical refining process. The chemical refining process may typically include the major steps of degumming, alkali refining, also called alkali neutralization, bleaching and deodorizing. The thus obtained deodorized oil is a chemically refined oil, also called “NBD” oil. Alternatively, the physical refining process may typically include the major steps of degumming, bleaching and deodorizing. A physically refining process does not include an alkali neutralization step as is present in the chemical refining process. The thus obtained deodorized oil is a physically refined oil, also called “RBD” oil.

In one example, the deodorized vegetable oil in step a) of the exemplary process is a physically refined oil.

The crude vegetable oil may be subjected to one or more degumming steps. Any of a variety of degumming processes known in the art may be used. One such process (known as “water degumming”) includes mixing water with the oil and separating the resulting mixture into an oil component and an oil-insoluble hydrated phosphatides component, sometimes referred to as “wet gum” or “wet lecithin”. Alternatively, phosphatide content can be reduced (or further reduced) by other degumming processes, such as acid degumming (using citric or phosphoric acid for instance), enzymatic degumming (e.g., ENZYMAX from Lurgi) or chemical degumming (e.g., SUPERIUNI degumming from Unilever or TOP degumming from VandeMoortele/Dijkstra CS). Alternatively, phosphatide content can also be reduced (or further reduced) by means of acid conditioning, wherein the oil is treated with acid in a high shear mixer and subsequently sent without any separation of the phosphatides to the bleaching step. If a degumming step is used, it will preferably precede the first bleaching step.

The bleaching step in general is a process step whereby impurities are removed to improve the color and flavor of the oil. It is typically performed prior to deodorization. The nature of the bleaching step will depend, at least in part, on the nature and quality of the oil being bleached. Generally, a crude or partially refined oil will be mixed with a bleaching agent which combines, amongst others, with oxidation products, phosphatides, trace soaps, pigments and other compounds to enable their removal. The nature of the bleaching agent can be selected to match the nature of the crude or partially refined oil to yield a desirable bleached oil. Bleaching agents generally include natural or “activated” bleaching clays, also referred to as “bleaching earths”, activated carbon and various silicates. Natural bleaching agent refers to non-activated bleaching agents. They occur in nature or they occur in nature and have been cleaned, dried, milled and/or packed ready for consumption. Activated bleaching agent refers to bleaching agents that have been chemically modified, for example by activation with acid or alkali, and/or bleaching agents that have been physically activated, for example by thermal treatment. Activation includes the increase of the surface in order to improve the bleaching efficiency

Further, bleaching clays may be characterized based on their pH value. Typically, acid-activated clays have a pH value of 2.0 to 5.0. Neutral clays have a pH value of 5.5 to 9.0. A skilled person will be able to select a suitable bleaching agent from those that are commercially available based on the oil being refined and the desired end use of that oil.

In one specific example of the exemplary refining process described above, the method for obtaining the deodorized vegetable oil that is used in step a) of the process, includes a bleaching step followed by a deodorization step.

The bleaching step takes place at a temperature of from about 80° C. to about 115°° C., from about 85° C. to about 110° C., from about 90° C. to about 105° C., or from 95° C. to about 100° C., in presence of neutral and/or natural bleaching earth in an amount of from about 0.2% to about 5%, from about 0.5% to about 3%, or from about 0.7% to about 1.5%.

The thus obtained bleached oil is subjected to a deodorization for preparing the deodorized vegetable oil that is used in step a) of the exemplary refining process described above.

Deodorization is a process whereby free fatty acids (FFAs) and other volatile impurities are removed by treating (or “stripping”) a crude or partially refined oil under vacuum with sparge steam, nitrogen or other gasses. The deodorization process and its many variations and manipulations are well known in the art and the deodorization step of the exemplary refining process described above may be based on a single variation or on multiple variations thereof.

For instance, deodorizers may be selected from any of a wide variety of commercially available systems (such as those sold by Krupp of Hamburg, Germany; De Smet Group, S. A. of Brussels, Belgium; Gianazza Technology s. r. l. of Legnano, Italy; Alfa Laval AB of Lund, Sweden Crown Ironworks of the United States, or others). The deodorizer may have several configurations, such as horizontal vessels or vertical tray-type deodorizers.

Deodorization is typically carried out at elevated temperatures and reduced pressure to better volatilize the FFAs and other impurities. The precise temperature and pressure may vary depending on the nature and quality of the oil being processed. The pressure, for instance, will preferably be no greater than 10 mm Hg but certain aspects of the invention may benefit from a pressure below or equal to 5 mm Hg, e.g. 1-4 mm Hg. The temperature in the deodorizer may be varied as desired to optimize the yield and quality of the deodorized oil. At higher temperatures, reactions which may degrade the quality of the oil will proceed more quickly. For example, at higher temperatures, cis-fatty acids may be converted into their less desirable transform. Operating the deodorizer at lower temperatures may minimize the cis-to-trans conversion, but will generally take longer or require more stripping medium or lower pressure to remove the requisite percentage of volatile impurities. As such, deodorization is typically performed at a temperature of the oil in a range of from about 200° C. to 280° C., with temperatures of about from 220° C. to about 270° C. being useful for many oils. Typically, deodorization is thus occurring in a deodorizer whereby volatile components such as FFAs and other unwanted volatile components that may cause off-flavors in the oil, are removed. Deodorization may also result in the thermal degradation of unwanted components.

In one specific example of the exemplary refining process described above, for obtaining the deodorized vegetable oil that is used in step a) of the process, the vegetable edible oil is deodorized at a temperature of from about 200° C. to about 270° C., from about 210° C. to about 260° C., from about 215° C. to about 250° C., from about 215° C. to about 245° C., or from 220° C. to about 240° C. The deodorization is taking place for a period of time from about 30 min to about 240 min, from about 45 min to about 180 min, from about 60 min to about 150 min, or from about 90 min to about 120 min.

In another specific example of the exemplary refining process described above, for obtaining the deodorized vegetable oil that is used in step a) of the process, the deodorization occurs in the presence of sparge steam in a range of from about 0.50% to about 2.50%, from about 0.75% to about 2.00%, from about 1.00% to about 1.75%, or from about 1.25% to about 1.50% and at an absolute pressure of about 7 mbar or less, about 5 mbar or less, about 3 mbar or less, or about 2 mbar or less.

In yet another specific example of the exemplary refining process described above, for obtaining the deodorized vegetable oil that is used in step a) of the process, the following steps are conducted, in order, of: i) Bleaching the vegetable oil at a temperature of from about 80° C. to about 115° C., from about 85° C. to about 110° C., from about 90° C. to about 100° C., or from about 95° C. to about 105° C., with neutral and/or natural bleaching earth in an amount of from about 0.2% to about 5%, from about 0.5% to about 3%, or from about 0.7% to about 1.5%, and ii) Deodorizing the vegetable oil at a temperature of from about 200° C. to about 270° C., from about 210° C. to about 260° C., from about 215° C. to about 250° C., from about 215° C. to about 245° C., or from about 220° C. to about 240° C., for a period of time from about 30 min to about 240 min, from about 45 min to about 180 min, from about 60 min to about 150 min, or from about 90 min to about 120 min.

The deodorized vegetable oil used in step a) of the process has a content of 3-MCPD esters that is about 2.5 ppm or more, about 3 ppm or more, about 3.5 ppm or more, about 4 ppm or more, about 4.5 ppm or more, or even about 5 ppm or more.

The deodorized vegetable oil used in step a) of the process has a content of GE that is about 1 ppm or more, about 2 ppm or more, about 3 ppm or more, about 4 ppm or more, about 5 ppm or more, about 10 ppm or more, or even about 15 ppm or more.

The process for preparing the deodorized oil used in step a) of the exemplary process may also optionally include steps that may have a beneficial effect on the prevention of formation and/or mitigation of unwanted process contaminants such as 3-MCPD and/or GE. These steps may be focused to reduce the content of chlorine, control the amount of phosphorous, include extra washing steps, use specific bleaching agents in significantly higher amounts than common processes, and the like.

### Process Step a)

The continuous pipe reactor in step a) of the exemplary refining process described above includes at least one cylindrical vessel which is designed to be able to operate at a temperature from about 100° C. to about 250° C., and wherein the vessel has at least one inlet suitable for deodorized vegetable edible oil and at least one outlet suitable for deodorized vegetable edible oil and characterized in that:
a) the reactor has a height to diameter ratio from about 3 to about 20, and
b) the reactor is able to operate such that the deodorized vegetable edible oil has a retention time distribution with a standard deviation of max about 40%.

The continuous pipe reactor in step a) of the process is a cylindrical vessel with an ellipsoidal or torispherical head and bottom. The reactor has a height to diameter ratio from about 3.0 to about 20.0, from about 4.0 to about 16.0, from about 4.5 to about 12.0, from about 5.5 to about 9.5, from about 6.0 to about 9.0, or from about 6.5 to about 9.0. In the “height to diameter ratio”, the diameter refers to the internal diameter of the reactor and the height refers to the height of the oil level in the reactor.

The continuous pipe reactor has more than one inlet suitable for deodorized edible oil and/or it is suitable for “one or more bases. The continuous pipe reactor may be equipped with multiple nozzles allowing injecting multiple streams of deodorized oil and/or multiple streams of the deodorized oil comprising the base.

The continuous pipe reactor has more than one inlet suitable for deodorized edible oil and/or it is suitable for “one or more bases. The continuous pipe reactor may be equipped with multiple nozzles allowing injecting multiple streams of deodorized oil and/or multiple streams of the deodorized oil including the base.

Further, the continuous pipe reactor may include more than one cylindrical vessel. The more than one cylindrical vessel can be provided in any type of set-up, sequential, in a carousel or any other type of set-up as long as in a height to diameter ratio of each and every cylindrical vessel is from about 3 to about 20, from about 4 to about 16, from about 4.5 to about 12, from about 5.5 to about 9.5, from about 6 to about 9, or from about 6.5 to about 9. In case of multiple cylindrical vessels, an approach of the plug flow is assured and the at least one inlet, and at least one outlet are set-up or designed to allow for such a flow of the deodorized oil including the base.

A base is added to the oil prior to entering the pipe reactor. The base may be added as a pure component or as a concentrated solution. The concentrated solution may be an aqueous solution with a concentration of from about 5 wt % to about 50 wt %, from about 10 wt % to about 40 wt %, from about 15 wt % to about 35 wt %, or from about 20 wt % to about 30 wt %. The base may be added by means of a static or dynamic mixer, or the like, for obtaining the oil including the base. The oil including the base is subsequently injected into the pipe reactor. Preferably the oil including the base is running top-down through the continuous pipe reactor. The oil including the base may be running through the pipe reactor at an absolute pressure from about −1.0 to about +0.5 barg. This pressure may be obtained by means of water-vapor or nitrogen. Preferably, the oil including the base is running through the pipe reactor at atmospheric pressure.

The oil including the base may be added to the pipe reactor by means of one or more spray nozzles. A nozzle is known to be a device designed to control the direction or characteristics of the fluid flow.

The addition of the base by means of one or more spray nozzles allow the oil including the base to be evenly distributed over the whole cross section area of the oil surface in the top of the reactor, while minimally disrupting the flow regime through the pipe reactor.

The flow regime of oil including the base in the continuous pipe reactor is similar to, or is at least approaching the flow regime of an ideal plug flow pipe reactor. The flow regime in the reactor is measured by the retention time distribution and can be expressed as a type of Gaussian curve around a mean residence time. It is important that the standard deviation of this retention time around this mean residence time is small such that in principle the oil including the base is moving smoothly with minimal disruptions through the pipe reactor. The standard deviation of the retention time is not more than about 40%, not more than about 30%, not more than about 20%, not more than about 10% of the mean residence time. The standard deviation is determined by calculating computational fluid dynamics and simulation with a step tracer injection. The flow regime of the oil in the continuous pipe reactor is similar to, or is at least approaching the flow regime of an ideal plug flow pipe reactor.

The treatment with the base is performed without injecting steam or gas into the oil including the base. Consequently, the flow regime of the oil including the base, flowing through the continuous pipe reactor, is not disturbed by the use of steam or gas. This is considerably different to a standard tray deodorizer where sparge steam is continuously added below the oil surface. This is considerably different from a standard tray deodorizer where sparge steam is continuously added below the oil surface.

The treatment with a base includes the addition of one or more bases. The “one or more bases” is selected from carbonate, bicarbonate, hydroxide, alkoxide, carboxylate and mixtures of two or more thereof. Preferable the one or more bases includes potassium hydroxide, sodium hydroxide, sodium palmitate and potassium palmitate. More preferably the one or more bases includes potassium hydroxide or potassium palmitate. Alternatively, the treatment with the base includes the addition of one or more bases and in situ formation of one or more carboxylates. In particular the carboxylate can be formed by adding one or more bases to the oil including a certain amount of free fatty acids.

In one specific example of the exemplary refining process described above, the base or one or more bases is added in a concentration of from about 0.06 mmol/kg to about 2.35 mmol/kg oil, from about 0.09 mmol/kg to about 1.76 mmol/kg oil, from about 0.12 mmol/kg to about 1.47 mmol/kg, from about 0.18 mmol/kg to about 0.71 mmol/kg, from about 0.29 mmol/kg to about 0.59 mmol/kg, or from about 0.35 mmol/kg to about 0.41 mmol/kg.

This can be further expressed such that, when the base is a hydroxide, it added in a concentration of from about 1.0 ppm to about 40.0 ppm of molar equivalents of hydroxide ions, from about 1.5 ppm to about 30.0 ppm, from about 2.0 ppm to about 25.0 ppm, from about 3.0 ppm to about 12.0 ppm, from about 5.0 ppm to about 10.0 ppm, from about 6.0 ppm to 7.0 ppm of molar equivalents of hydroxide ions. When the base is a palmitate, it added in a concentration of from about 15.0 ppm to about 601.0 ppm, from about 22.5 ppm to about 450.7 ppm, from about 30.0 ppm to about 375.6 ppm, from about 45.1 ppm to about 180.3 ppm, from about 75.1 ppm to about 150.2 ppm, or from about 90.1 ppm to about 105.2 ppm of molar equivalents of palmitate ions.

The treatment with a base is performed at a temperature from about 160° C. to about 220° C., from about 165° C. to about 215° C., from about 170° C. to about 210° C., from about 175° C. to about 205° C., from about 180° C. to about 200° C., from about 185° C. to about 195° C., or from about 190° C. to about 195° C.

The mean retention time in the continuous pipe reactor is at least about 30 minutes, at least about 60 minutes, at least about 90 minutes, at least about 120 minutes, at least about 130 minutes and up to about 180 minutes.

The treatment with the base is reducing in the oil the content of the 3-MCPD esters below about 2.5 ppm, below about 1.9 ppm, below about 1.8 ppm, below about 1.5 ppm, below about 1.2 ppm, below about 1 ppm, or below about 0.8 ppm. The treatment with the base is reducing the content of the 3-MCPD esters with more than about 20%, more than about 30%, more than about 40%, more than about 50%, more than about 60%, more than about 70%, more than about 75%, more than about 80%, more than about 85%, or more than about 90%.

### Process Step b)

The process of the exemplary refining process described above further includes a step b) of contacting the base treated oil with an adsorbent and/or an acid.

The adsorbent can be selected from bleaching agent, activated carbon, zeolite, exchange resin, silica and/or two or more combinations thereof. Examples of silica that can be employed in the present process include magnesium silicate, calcium silicate, aluminum silicate and combinations thereof. The activated carbon is preferably acidic activated carbon. The exchange resin is preferably a cation exchange resin. The bleaching agent can be neutral or activated bleaching agent. Activated bleaching agent refers to acid and/or physically activated (e.g. by thermal treatment). Activation includes the increase of the surface in order to improve the bleaching efficiency. Preferably an acid activated bleaching agent is applied. The acid is provided as an aqueous solution. The acid may include phosphoric acid, sulfuric acid, ascorbic acid, citric acid, erythorbic acid, acetic acid, malic acid or combinations of two or more thereof.

The amount of adsorbent is in the range of from about 0.3 wt % to about 4 wt % by weight of oil, in the range from about 0.4 wt % to about 3wt %, from about 0.5 wt % to about 2.5 wt %, from about 0.6 wt % to about 2 wt %, from about 0.7 wt % to about 1.5 wt %, or from about 0.8 wt % to about 1.2 wt %.

The amount of acid that is added to the base-treated oil is equivalent or about 15% less than, about 10% less than, about 5% less than the molar amount of OH ions, or carboxylate (palmitate)-ions added during the treatment of the deodorized oil with a base. The acid may be added as an aqueous solution with a concentration of from about 5% to about 85%, from about 20% to about 70%, or from about 30% to about 60%. Typically, an 50% citric acid solution is used.

The temperature of the contacting step b) is in the range of from about 70° C. to about 120° C., in the range of about 80° C. to about 110° C., or in the range of about 85° C. to about 100° C.

The contact time with the adsorbent and/or acid in step b) of the present process is in a range of from 15 to 60 minutes, from 20 to 50 minutes, from 30 to 45 minutes.

At the end of step b) the oil is separated from the adsorbent and/or soaps formed.

It is believed that step b) of the process of the exemplary refining process described above allows to reduce the content of glycidyl esters (GE). The content of glycidyl esters can be reduced to below LOQ (limit of quantification). Thus, the content of glycidyl esters can be reduced to below about 0.10 ppm. Furthermore, step b) allows to remove soap and/or reduce the color of the base treated oil.

Step b) of the process of the present invention may be a single step wherein the base treated oil is contacted with one or more adsorbents and/or one or more acids. Alternatively, step b) of the process may include multiple steps wherein the based treated oil is contacted with different adsorbents and/or acids in consecutive steps.

In one specific example of the exemplary refining process described above, the process includes a step b) of contacting the base treated oil with an adsorbent, or with an adsorbent and an acid.

In another specific example of the exemplary refining process described above, the process includes a step b) of contacting the base treated oil with an adsorbent and an acid and step b) includes:
b1) contacting the base-treated oil with an acid,
b2) optionally removing the soap formed, and
b3) contacting the base-treated oil with an acid-activated bleaching earth,
   wherein the acid in step b1) is phosphoric acid, sulfuric acid, ascorbic acid, citric acid, erythorbic acid, acetic acid, malic acid or combinations of two or more thereof, preferably citric acid.

In another specific example of the exemplary refining process described above, the process includes a step b) of contacting the base treated oil with an adsorbent and an acid and step b) includes:
b1) contacting the base-treated oil with an acid,
b2) removing the soap formed, and
b3) contacting the base-treated oil with an acid-activated bleaching earth,
   wherein the acid in step b1) is phosphoric acid, sulfuric acid, ascorbic acid, citric acid, erythorbic acid, acetic acid, malic acid or combinations of two or more thereof, preferably citric acid.

The soap in step b2) of the process may be removed by contacting the oil obtained from step b1) with an adsorbent, such as bleaching earth or silica. Preferably, silica is used to remove soaps in step b2) of the process.

Contacting the based-treated oil first with an acid and removing the soap formed, may allow the acid-activated bleaching earth, that is subsequently added to the based-treated oil to reduce more effectively GE and color. As a result, less acid-activated bleaching earth may be needed.

After step b), the color of the base-treated oil is low.

In another specific example of the exemplary refining process described above, the base-treated palm based-oil after step b) of the present process is characterized by a Lovibond red colour of about 3.5R or less, about 3R or less, about 2.5R or less, about 2R or less and/or a Lovibond yellow colour of about 35Y or less, about 30Y or less, about 25Y or less, about 20Y or less (measured in a 5¼ inch glass measuring cell according to AOCS method Ccl3e-92).

### Further Fractionation Step and/or Refining Steps

In another example of the exemplary refining process described above, the process may include a further processing step carried out after step b) and wherein the further processing step is a fractionation step and/or a further refining step.

In particular the further processing step is a fractionation step of the deodorized base-treated palm oil. The fatty acid distribution in palm oil lends itself into fractionation and the production of multiple fractions of palm oil. Palm oil fractions may comprise palm olein, palm stearin and fractions further obtained through re-fractionation, either from the palm olein or palm stearin, such as palm mid-fraction, double fractionated palm olein, also called super olein, double fractionated stearin, also called super stearin, and even further fractions obtained through re-fractionation of palm-mid fraction. The presence of trisaturated and disaturated triglycerides in the palm oil facilitates the formation of fat crystals, in particular as the oil is chilled. On the contrary, when the position of the fatty acids of the triglycerides is changed or disrupted by interesterification, the fractionation is hampered and will be cumbersome. By applying the exemplary refining process described above, the degree of interesterification is kept low and thus the fractionation is facilitated. Any suitable fractionation method can be applied. In fact, the process of the present invention is beneficial for any subsequent step where oil crystallization can be a determining factor.

In another specific example of the exemplary process described above, the further processing step is a further refining step.

The “further refining step” is carried out at a temperature below about 220° C., below about 215° C., below about 210° C., below about 200° C., below about 190° C., below about 185° C., below about 180° C., from about 130° C. to about 210° C., or from about 150° C. to about 175° C.

The “further refining step” may result in a refined vegetable oil having a reduced content of 3-MCPD esters, a reduced content of GE and a taste that is acceptable to good. The refined vegetable oil has a content of the 3-MCPD esters below about 2.5 ppm, below about 1.9 ppm, below about 1.8 ppm, below about 1.5 ppm, below about 1.2 ppm, below about 1 ppm, below about 0.8 ppm. The GE content of the refined vegetable oil is below about 1.0 ppm, below about 0.7 ppm, below about 0.5 ppm, or even below about 0.3 ppm. The refined vegetable has an overall flavour quality score (taste), according to AOCS method Cg 2-83, in a range of from about 7 to about 10, or even from about 8 to about 10 (with 10 being an excellent overall flavour quality score and 1 being the worst score) or from about 9 to about 10.

The “further refining step” is carried out in a deodorizer, or preferably in an oil refining equipment consisting of a stripping column with packing and not more than one oil collection tray.

In one specific example, the “further refining step” is carried out in an oil refining equipment consisting of a stripping column with packing and not more than one oil collection tray. The refining ability of this refining equipment is obtained from the use of the stripping column and not more than one oil collection tray. It is to be understood that in order to operate the refining equipment, valves, pumps, heat exchangers (heating and/or cooling of the oil), and the like, are needed. An in-line heater may be used before the stripping column.

The “not more than one” oil collection tray is a range covering “up to one” collection tray, and thus including also no collection tray.

The “oil refining equipment” is not containing retention trays. Retention trays, retention vessels, or compartments, also known as sections, are always present in standard deodorizer equipment known in the art, whether batch, continuous or semi-continuous deodorizer equipment.

In each tray the oil is kept for a certain time at high temperature and steam is introduced into the oil.

It has been found that the height to diameter ratio of the stripping column of the oil refining equipment is from about 0.1 to about 10.

The packing can be random packing or structured packing. Preferably the packing is a structured packing.

The term structured packing is well-known in the technical field, and it refers to a range of specially designed materials for use in absorption and distillation columns. Structured packings typically consist of thin corrugated metal plates arranged in a way that force fluids to take complicated paths through the column and thereby creating a large surface, which can enhance the interaction between oil and stripping agent.

The packing in the equipment of the present invention is having a specific surface of from about 100 to about 750 m²/m³.

Furthermore, the stripping column of the oil refining equipment has an oil loading of from about 0.5 kg/m²h to 4.0 kg/m²h surface of packing.

The “oil refining equipment” allows for a short residence (retention) time. In particular, a total residence time in the refining equipment, including not more than one collection tray, and including a pre-heating (using a heating device prior to passing the oil through the oil refining equipment), is not more than about 20 minutes. More in particular, the process of the present invention allows a residence time in the packing of the stripping column of from about 1 to about 10 minutes.

These short residence times are further beneficial to avoid further formation of the process contaminants.

The stripping agent is steam or any other stripping gas, such as nitrogen gas. Preferably steam is used as stripping agent.

The stripping column is operated at an absolute pressure of below about 8 mbar.

In one example of the exemplary refining process described above, the process includes the following steps:
a) Treating a deodorized vegetable oil with a base in a continuous pipe reactor,
b) Contacting the base treated oil with an adsorbent or an adsorbent and an acid,
c) Treating the oil of step b) in a further refining step carried out in a deodorizer at a temperature below about 220° C., below about 215° C., below about 210° C., below about 200° C., below about 190° C., below about 185° C., below about 180° C., from about 130° C. to about 210° C., or from about 150° C. to about 175° C.

In another example of the exemplary refining process described above, the process includes the following steps:
a) Treating a deodorized vegetable oil with a base in a continuous pipe reactor,
b) Contacting the base treated oil with an adsorbent or an adsorbent and an acid,
c) Treating the oil of step b) in a further refining step carried out in a deodorizer at a temperature below about 220° C., below about 215° C., below about 210° C., below about 200° C., below about 190° C., below about 185° C., below about 180° C., from about 130° C. to about 210° C., from about 150° C. to about175° C., and
   Wherein the vegetable oil is palm oil, palm oil stearin, palm oil super stearin, palm oil olein, palm oil super olein, palm oil mid-fraction or blends of one or more thereof.

In a yet further example of the exemplary refining process described above, the process includes the following steps:
a) Treating a deodorized palm oil with a base in a continuous pipe reactor,
b) Contacting the base treated palm oil with an adsorbent or with an adsorbent and acid,
c) Treating the palm oil of step b) in a further refining step carried out in a deodorizer at a temperature below about 220° C., below about 215° C., below about 210° C., below about 200° C., below about 190° C., below about 185° C., below about 180° C., from about 130°° C. to about 210° C., from about 150° C. to about 175° C.,
d) Treating the palm oil of step c) in a fractionation step.
e) Collecting the fractions obtained in step d).

In yet another example of the exemplary refining process described above, the process includes the following:
a) Treating a deodorized vegetable oil with a base in a continuous pipe reactor,
b) Contacting the base treated oil with an adsorbent and/or acid,
c) Treating the oil of step b) in a further refining step carried out in in an oil refining equipment consisting of a stripping column with packing and not more than one oil collection tray and at a temperature below about 220° C., below about 215° C., below about 210° C., below about 200° C., below about 190° C., below about 185° C., below about 180° C., from about 130° C. to about 210° C., or from about 150° C. to about 175° C.

In yet another example of the exemplary refining process described above, the process for manufacturing a refined vegetable oil with a reduced content of 3-MCPD esters is characterized in that it comprises the following:
a) Treating a deodorized vegetable oil with a base in a continuous pipe reactor,
b) Contacting the base treated oil with an adsorbent and/or acid,
c) Treating the oil of step b) in a further refining step carried out in in an oil refining equipment consisting of a stripping column with packing and not more than one oil collection tray and at a temperature below about 220° C., below about 215° C., below about 210° C., below about 200° C., below about 190° C., below about 185° C., below about 180° C., from about 130° C. to about 210° C., or from about 150° C. to about 175° C., and
   Wherein the vegetable oil is palm oil, palm oil stearin, palm oil super stearin, palm oil olein, palm oil super olein, palm oil mid-fraction or blends of one or more thereof.

In another example of the exemplary refining process described above, the process includes the following:
a) Treating a deodorized palm oil with a base in a continuous pipe reactor,
b) Contacting the base treated palm oil with an adsorbent and/or acid, c) Treating the palm oil of step b) in a further refining step carried out in an oil refining equipment consisting of a stripping column with packing and not more than one oil collection tray and at a temperature below about 220° C., below about 215° C., below about 210° C., below about 200° C., below about 190° C., below about 185° C., below about 180° C., from about 130° C. to about 210° C., or from 150° C. to about 175° C.,
d) Treating the palm oil of step d) in a fractionation step,
e) Collecting the fractions obtained in step e).

The oil obtained with the exemplary refining process described above, is the first, second and/or third ingredient of the triglyceride composition of the present invention.

### EXAMPLES—OIL COMPOSITION FORMULATION

In the following examples, various oil compositions are tested to explore the aroma, mouthfeel and/or taste thereof, either in pure form or as a non-dairy creamer added to beverages.

Palm olein is imported from Malaysia, southeast Asia, and serves as the starting material to provide the various palm oil derivatives discussed herein. Among those palm oil derivatives, ROL refers to palm olein refined according to the conventional refining process, and RROL refers to palm olein refined twice according to the conventional refining process. RRPS refers to palm stearin refined twice according to the conventional refining process. SROL refers to refined palm olein according to the refining process described in PCT application WO 2020/197770 A1 by Cargill noted above, SRPS refers to refined palm stearin refined according to the refining process described in PCT application WO 2020/197770 A1 by Cargill. RRPKOL refers to palm kernel olein refined twice according to the conventional refining process.

In each example, the sensory tests are conducted are conducted by a sensory panel to assess the aroma and flavor of various oil compositions. The sensory panel consists of five trained, experienced panelists who have sensory sensitivity higher than 80% of people.

All sensory tests are conducted in an assessment room with good ventilation, such that no odor from the environment would interfere with the assessment of the panelists. The room temperature is set to be from about 20° C. to about 25° C., and is kept quite throughout the entire sensory test. Each panelist does not wear any makeup or other cosmetics with fragrance.

Before assessing a sample, a panelist rinses his or her mouth with water, and chews a biscuit. Every part inside the oral cavity of the panelist should have contacted the crushed biscuit. Then each panelist rinses his or her mouth with water again, and take a break of about 5 minutes before proceeding to test the sample.

When a panelist assesses a sample for its smell, he or she smells the sample as he or she slightly shakes the sample vial such that air carrying the odor molecules of the sample is slowly inhaled by the panelist. He or she then scores the sample for its smell.

When a panelist assesses a sample for its taste, he or she takes a sip of the sample, and ensures that the sipped sample slowly flows inside his or her oral cavity and every part thereof should have contacted the sipped sample. Then the panelist spits the sample out. He or she then scores the sample for its taste.

In all examples, acid value (“AV”) is determined in accordance with Chinese National Food Safety Standard GB 5009.229. Peroxide value (“PV”) is determined in accordance with Chinese National Food Safety Standard GB 5009.227. Slip melting point (“SMP”) is determined in accordance with AOCS Official Method Cc-25. Solid fat content (“SFC”) is determined in accordance with International Union of Pure and Applied Chemistry Method 2.150. 3-MCPD and GE are determined in accordance with Method DGF Standard Methods Section C (Fats) C-VI 18 (10).

### Example 1

ROL, SROL and RROL are tested for their aroma and taste.

The sensory panel of five well trained panelists is asked to score on a scale of 1 to 10 each oil sample for its aroma and flavor respectively. The aroma and flavor of each sample is evaluated in accordance with the sensory criteria set forth below in Table 1.

TABLE 1

| | Aroma | | Flavor | |
|---|---|---|---|---|
| Serials No. | description | Aroma Score | description | Flavor Score |
| 1 | Bland | 10 | Bland | 10 |
| 2 | Trace | 9 | Trace | 9 |
| 4 | Faint | 8 | Faint | 8 |
| 4 | Slight | 7 | slight | 7 |
| 5 | Mild | 6 | mild | 6 |
| 5 | Moderate | 5 | moderate | 5 |
| 6 | Definite | 4 | definite | 4 |
| 8 | Strong | 3 | strong | 3 |
| 9 | Very strong | 2 | Very strong | 2 |
| 10 | Extreme | 1 | Extreme | 1 |

The results of the sensory tests are summarized in Table 2.

TABLE 2

| | ROL | SROL | RROL |
|---|---|---|---|
| PV(mmol/kg) | 0.49 | 0 | 0 |
| AV(mgKOH/g) | 0.25 | 0.09 | 0.07 |
| Aroma score | 6 | 9 | 8 |
| Flavor score | 6 | 9 | 7 |
| 3-MCPD ester | 4626 | 1278 | 3552 |
| content (ppb) | | | |
| GE content (ppb) | 5898 | 352 | 2436 |

It can be seen from the above that SROL, which has the lowest 3-MCPD and GE content, displays superior aroma and flavor compared to ROL and RROL.

Example 2

In this example, blended palm oil derivatives are tested for their flavor, mouthfeel and texture to simulate those of hydrogenated soybean oil (referred to as “HSBO”). As discussed above, RRPKOL refers to palm kernel olein refined twice according to the conventional refining process, and has low contaminant level (i.e., low in 3-MCPD esters and GE).

Two compositions, composition E (SROL+SRPS+RRPKOL) and F (HSBO), are prepared in accordance with Table 3. Tea is made and is divided into two equal volumes, and the compositions E and F are respectively added, in the same weight amount, to a corresponding volume as non-dairy creamers to make milk tea.

The sensory panel is asked to score on a scale of 1 to 10 each milk tea with the compositions E and F respectively, in terms of flavor, mouthfeel and texture. The composition F is used as control and is assigned a score of 10 in each evaluation aspect. The evaluation results by the sensory panel are summarized below in Table 3.

TABLE 3

| | E | F |
|---|---|---|
| Oil composition | 55% SROL + 17% SRPS + 28% RRPKOL | HSBO |
| TFA (%) | 0.7 | 42.8 |
| 3-MCPD ester | 1137 | 684 |
| content (ppb) | | |
| GE content (ppb) | 680 | 138 |
| Pleasant flavor | 9 | 10 |
| Milky flavor | 9 | 10 |
| Smoothness | 10 | 10 |
| Richness | 9 | 10 |

It can be seen from the above that composition E, which is made by blending SROL and SRPS with a lauric fat (i.e., RRPKOL) of low 3-MCPD ester and GE content, delivers mouthfeel, flavor and texture similar to HSBO when used as a non-dairy creamer.

The fatty acid profile of the composition E is shown in Table 4.

TABLE 4

| Fatty Acid | Content (%) |
|---|---|
| C6:0 | 0.1 |
| C8:0 | 1.3 |
| C10:0 | 1.1 |
| C12:0 | 12.9 |
| C14:0 | 4.6 |
| C16:0 | 34.9 |
| C16:1 | 0.1 |
| C17:0 | 0.1 |
| C17:1 | 0.0 |
| C18:0 | 3.9 |
| C18:1 | 32.8 |
| C18:2 | 7.6 |
| C18:3 | 0.1 |
| C20:0 | 0.3 |
| C20:1 | 0.1 |
| C20:2 | 0.0 |
| C21:0 | 0.0 |
| C22:0 | 0.0 |
| C22:2 | 0.0 |
| C24:0 | 0.0 |
| C24:1 | 0.0 |
| TFA | 0.7 |

It can be seen from the above that the main saturated fatty acids in the composition E are lauric acid (C12:0), palm acid (C16:0) and stearic acid (C18:0). Without intending to be bound by theory, it is believed that the specific content of the saturated fatty acids in the composition contribute to the improved flavor and mouthfeel of the composition. Specifically, it is believed that a lauric acid content of from about 8 wt % to about 25 wt %, a palm acid content of from about 20 wt % to about 60 wt %, and a stearic acid content of from about 3 wt % to about 15 wt %, by weight of the total fatty acid content, contribute to the simulation of the flavor and mouthfeel of a hydrogenated oil. It is also believed that a lauric acid content of from 10 wt % to about 25 wt %, or from about 10.5 wt % to about 20 wt %, or from about 11 wt % to about 15 wt % may be preferred; a palm acid content of from about 25 wt % to about 55 wt %, or from about 30 wt % to about 4 0wt % may be preferred; and/or a stearic acid content of from about 3 wt % to about 10 wt %, or from about 3.3 wt % to about 6 wt %, or from about 3.5wt % to about 5.5wt % may be preferred.

Without intending to be bound by theory, it is believed that the introduction of the lauric fat makes the melting point of the composition more close to that of the hydrogenated oils, thereby resulting in mouthfeel and texture more similar to those of the hydrogenated oils. The improved mouthfeel and texture in turn have a positive effect on the taste profile of the composition, showcasing the pleasant and milky flavor thereof.

Another example of non-dairy creamer:

| | |
|---|---|
| Triglyceride composition of present | 30% |
| invention | |
| Glucose syrup | 63% |
| Sodium caseinate | 2.5% |
| Emulsifier | 3% |
| Buffer agent(K2PO4) | 2% |
| Total | 100% |

Unless otherwise defined, all terms (including technical and scientific terms) used herein have the same meaning as commonly understood by one of ordinary skill in the art to which the examples of the invention belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

While the disclosure has been described with reference to an exemplary examples, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular example disclosed as the best mode contemplated for carrying out this disclosure, but that the disclosure will include all examples falling within the scope of the appended claims.

All references specifically cited herein are hereby incorporated by reference in their entireties. However, the citation or incorporation of such a reference is not necessarily an admission as to its appropriateness, citability, and/or availability as prior art to/against the present invention.

### CLAUSES OF THE INVENTION

Clause 1. A triglyceride composition comprising a first ingredient, a second ingredient and a third ingredient, characterized in that:
A. the first ingredient and the second ingredient together are from about 65 wt % to about 80 wt % by the weight of the triglyceride composition, and the third ingredient is from about 20 wt % to about 35 wt % by weight of the triglyceride composition,
B. the first ingredient, the second ingredient and the third ingredient each have a MCPD content of less than 2500 ppb and a GE content of less than 1000 ppb,
C. the first ingredient and the second ingredient are different, and the first ingredient and second ingredient are each selected from the group consisting of palm oil, palm kernel oil, palm kernel olein, palm kernel stearin, palm stearin, palm super stearin, palm olein, palm super olein, palm mid-fraction and a combination thereof, and
D. the third ingredient comprises a lauric triglyceride.

Clause 2. The triglyceride composition according to clause 1, wherein the first ingredient, the second ingredient and the third ingredient each have a MCPD content of less than 1500 ppb and a GE content of less than 500 ppb.

Clause 3. The triglyceride composition according to aspect 1 or 2, wherein the first and second ingredients together are from 68 wt % to about 78 wt %, by weight of the triglyceride composition; or from about 70 wt % to about 7 5wt %, by weight of the triglyceride composition.

Clause 4. The triglyceride composition according to any one of the preceding clauses, wherein the third ingredient is from about 23 wt % to about 33 wt %, by weight of the triglyceride composition; or from about 25 wt % to about 30 wt %, by weight of the triglyceride composition.

Clause 5. The triglyceride composition according to any one of the preceding clauses, wherein the triglyceride composition has a lauric acid content of from about 8 wt % to about 25 wt %, or from 10 wt % to 2 5wt %, or from about 10.5 wt % to about 20 wt %, or of from about 11 wt % to about 15 wt %, by weight of the total fatty acid content; a palm acid content of from about 20 wt % to about 60 wt %, or from about 25 wt % to about 55 wt %, or from about 30 wt % to about 40 wt %, by weight of the total fatty acid content; and a stearic acid content of from about 3 wt % to about 15 %, or from about 3 wt % to about 10 wt %, or from about 3.3 wt % to about 6 wt %, or of from about 3.5 wt % to about 5.5 wt %, by weight of the total fatty acid content.

Clause 6. The triglyceride composition according to any one of the preceding clauses, wherein ratio of the first ingredient to the second ingredient is from about 3 to about 6; or from about 3.1 to about 5.9; or from about 3.2 to about 5.7.

Clause 7. The triglyceride composition according to any one of the preceding clauses, wherein the first ingredient and the second ingredient are each selected from the group consisting of palm olein, palm stearin and a combination thereof, the first ingredient being different from the second ingredient; or the first ingredient is palm olein, and the second ingredient is palm stearin.

Clause 8. The triglyceride composition according to any one of the preceding clauses, wherein the third ingredient is selected from the group consisting of palm kernel oil, palm kernel olein, palm kernel stearin, coconut oil, and a combination thereof; or is palm kernel olein.

Clause 9. A non-dairy creamer comprising a triglyceride composition according to any one of clauses 1 to 8.

Clause 10. The non-dairy creamer according to clause 9 that is further comprising an ingredient selected from the group consisting of a sweetening substance, an antioxidant, a filler, a protein strengthener, a flavoring substance, a pigment, a flavor/mouthfeel enhancer, a thickening, gelling, stabilizing or emulsifying agent, a health boosting ingredient, a solvent and a combination thereof.

Clause 11. The non-dairy creamer according to clause 10, wherein the sweetening substance is selected from the group consisting of a sugar, a sugar substitute, and a combination thereof; or selected from the group consisting of acesulfame potassium, alitame, aspartame, cyclamate, saccharin, sucralose, thaumatin, neotame, sucrose, fructose, isomalt, lactitol, mannitol, maltitol, xylitol, sorbitol, steviol glycoside and a combination thereof.

Clause 12. The non-dairy creamer according to any one of clauses 10 to 11, wherein the flavoring substance is selected from the group consisting of a vanilla extract, vanillin, a banana flavoring oil or extract, almond flavoring oil or extract, coconut flavoring oil or extract, coffee flavoring oil or extract, hazelnut flavoring oil or extract, cinnamon flavoring oil or extract, tea flavoring oil or extract, pecan flavoring oil or extract, caramel flavoring or extract, turmeric flavoring or extract, soy flavoring or extract and a combination thereof.

Clause 13. The non-dairy creamer according to any one of clauses 10 to 12 wherein the triglyceride composition according to any one of clauses 1 to 8 is present in an amount of 20 wt. % to 100 wt. % based upon the total weight of the non-dairy creamer.

Clause 14. The non-dairy creamer according to any one of clauses 10 to 13 wherein triglyceride composition according to any one of clauses 1 to 8 is present in an amount of at least 25 wt. % up to 100 wt. %, at least 30 wt. %, at least 40 wt. %, at least 45 wt. % and up to 80 wt. %, up to 85 wt. %, up to 95 wt. % based upon the total weight of the non-dairy creamer.

Clause 15. The non-dairy creamer according to any one of clauses 10 to 14 wherein the triglyceride composition according to any one of clauses 1 to 8 is present in an amount of from 25 wt. % up to 35 wt. % based upon the total weight of the non-dairy creamer.

Clause 16. The non-dairy creamer according to any one of clauses 10 to 14 wherein the triglyceride composition according to any one of clauses 1 to 8 is present in an amount of from 75 wt. % to 100 wt. %, based upon the total weight of the non-dairy creamer.

Clause 17. The non-dairy creamer according to any one of clauses 10 to 16 wherein the non-dairy is further comprising the sweetening substance in an amount of from 0 to 78 wt. %, preferably 60 wt. % to 70 wt. % based upon the total weight of the non-dairy creamer.

Clause 18. The non-dairy creamer according to any one of clauses 10 to 17 wherein the sweetening substance is present in an amount of 63 wt. % to 75 wt. %, based upon the total weight of the non-dairy creamer.

Clause 19. Use of a triglyceride composition according to any one of clauses 1 to 8 or non-dairy creamer according to any one of clauses 9 to 18 to improve a sensory property of a beverage, the sensory property being selected from the group consisting of flavor, aroma, mouthfeel and a combination thereof.

Clause 20. The use according to clause 19, wherein the beverage is selected from the group consisting of tea, coffee, chocolate drink, milkshake, smoothie, cocktail and a combination thereof.

Clause 21. The use according to clause 19 or 20, wherein the triglyceride composition is used as a non-dairy creamer.

Clause 22. The use according to any one of clauses 19 to 21, wherein the triglyceride composition simulates the sensory property of hydrogenated coconut oil, partially hydrogenated soybean oil and/or hydrogenated palm kernel oil.

Clause 23. A beverage comprising the triglyceride composition according to any one of clauses 1 to 8 or non-dairy creamer according to any one of clauses 9 to 18, wherein the beverage is selected from the group consisting of tea, coffee, chocolate drink, milkshake, smoothie, cocktail and a combination thereof.

Clause 24. A method for preparing a triglyceride composition for use as a non-dairy creamer of a beverage, comprising:
(A) providing a first ingredient, wherein the first ingredient is palm oil or palm oil derivative having a MCPD content of less than 2500 ppb and a GE content of less than 1000 ppb;
(B) providing a second ingredient, wherein the second ingredient is palm oil or palm oil derivative having a MCPD content of less than 2500 ppb and a GE content of less than 1000 ppb;
(C) providing a third ingredient, wherein the third ingredient comprises lauric triglyceride and has a MCPD content of less than 2500 ppb and a GE content of less than 1000 ppb; and
(D) mixing the first ingredient, the second ingredient with the third ingredient to provide the triglyceride composition,
   wherein the first ingredient and the second ingredient together are from about 65 wt % to about 8 0wt % by the weight of the triglyceride composition, and the third ingredient is from about 20 wt % to about 35 wt % by weight of the triglyceride composition, and wherein the first ingredient and the second ingredient are different, and the first ingredient and second ingredient are each selected from the group consisting of palm oil, palm kernel oil, palm kernel olein, palm kernel stearin, palm stearin, palm super stearin, palm olein, palm super olein, palm mid-fraction and a combination thereof.

Clause 25. The method according to clause 24 comprising:
a) Treating a deodorized vegetable oil with a base in a continuous pipe reactor,
b) Contacting the base treated ingredient of step a) with an adsorbent or an adsorbent and an acid and obtaining the deodorized first, second and/or third ingredient.

Clause 26. The method according to any one of claims 24 to 25 comprising degumming, bleaching and deodorizing the vegetable oil, followed by
a) Treating the deodorized first, second and/or third ingredient with a base in a continuous pipe reactor,
b) Contacting the base treated ingredient of step a) with an adsorbent or an adsorbent and an acid, and obtaining the first, second and/or third ingredient.

Clause 27. The method according to any one of clauses 24 to 26 wherein the deodorized vegetable oil is obtained by i) Bleaching the ingredient that is a vegetable oil at a temperature of from about 80° C. to about 115° C., from about 85° C. to about 110° C., from about 90° C. to about 100° C., or from about 95° C. to about 105° C., with neutral and/or natural bleaching earth in an amount of from about 0.2% to about 5%, from about 0.5% to about 3%, or from about 0.7% to about 1.5%, and ii) Deodorizing the vegetable oil at a temperature of from about 200° C. to about 270° C., from about 210° C. to about 260° C., from about 215° C. to about 250° C., from about 215° C. to about 245° C., or from about 220° C. to about 240° C., for a period of time from about 30 min to about 240 min, from about 45 min to about 180 min, from about 60 min to about 150 min, or from about 90 min to about 120 min.

Clause 28. The method according to any one of clauses 24 to 27 comprising:
a) Treating the deodorized vegetable oil with a base in a continuous pipe reactor,
b) Contacting the base treated oil with an adsorbent or an adsorbent and an acid,
c) Treating the oil of step b) in a further refining step carried out in a deodorizer at a temperature below about 220° C., below about 215° C., below about 210° C., below about 200° C., below about 190° C., below about 185° C., below about 180° C., from about 130° C. to about 210° C., or from about 150° C. to about 175° C., and obtaining first, second and/or third ingredient.

1. A triglyceride composition comprising a first ingredient, a second ingredient and a third ingredient, characterized in that:
A. the first ingredient and the second ingredient together are from about 65 wt % to about 80 wt % by the weight of the triglyceride composition, and the third ingredient is from about 20 wt % to about 35 wt % by weight of the triglyceride composition,
B. the first ingredient, the second ingredient and the third ingredient each have a MCPD content of less than 2500 ppb and a GE content of less than 1000 ppb,
C. the first ingredient and the second ingredient are different, and the first ingredient and second ingredient are each selected from the group consisting of palm oil, palm kernel oil, palm kernel olein, palm kernel stearin, palm stearin, palm super stearin, palm olein, palm super olein, palm mid-fraction and a combination thereof, and
D. the third ingredient comprises a lauric triglyceride.

2. The triglyceride composition according to claim 1, wherein ratio of the first ingredient to the second ingredient is from about 3 to about 6.

3. The triglyceride composition according to claim 1, wherein the first ingredient and the second ingredient are each selected from the group consisting of palm olein, palm stearin and a combination thereof, the first ingredient being different from the second ingredient.

4. The triglyceride composition according to claim 1, wherein the third ingredient is selected from the group consisting of palm kernel oil, palm kernel olein, palm kernel stearin, coconut oil, and combinations thereof.

5. A non-dairy creamer comprising a triglyceride composition according to claim 1.

6. The non-dairy creamer according to claim 5 that is further comprising an ingredient selected from the group consisting of a sweetening substance, an antioxidant, a filler, a protein strengthener, a flavoring substance, a pigment, a flavor/mouthfeel enhancer, a thickening, gelling, stabilizing or emulsifying agent, a health boosting ingredient, a solvent and a combination thereof.

7. The non-dairy creamer according to claim 6, wherein the sweetening substance is selected from the group consisting of a sugar, a sugar substitute, and combinations thereof.

8. The non-dairy creamer according to claim 5, wherein the triglyceride composition of claim 1 is present in an amount of 20 wt. % to 100 wt %.

9-12. (canceled)

13. A beverage comprising the triglyceride composition according to claim 1 or non-dairy creamer according to claim 5, wherein the beverage is selected from the group consisting of tea, coffee, chocolate drink, milkshake, smoothie, cocktail and combinations thereof.

14. A method for preparing a triglyceride composition for use in a non-dairy creamer of a beverage, comprising:
(A) providing a first ingredient, wherein the first ingredient is palm oil or palm oil derivative having a MCPD content of less than 2500 ppb and a GE content of less than 1000 ppb;
(B) providing a second ingredient, wherein the second ingredient is palm oil or palm oil derivative having a MCPD content of less than 2500 ppb and a GE content of less than 1000 ppb;
(C) providing a third ingredient, wherein the third ingredient comprises lauric triglyceride and has a MCPD content of less than 2500 ppb and a GE content of less than 1000 ppb; and
(D) mixing the first ingredient and the second ingredient with the third ingredient to provide the triglyceride composition,
wherein the first ingredient and the second ingredient together are from about 65 wt % to about 80 wt % by the weight of the triglyceride composition, and the third ingredient is from about 20wt % to about 35wt % by weight of the triglyceride composition, and
wherein the first ingredient and the second ingredient are different, and the first ingredient and second ingredient are each selected from the group consisting of palm oil, palm kernel oil, palm kernel olein, palm kernel stearin, palm stearin, palm super stearin, palm olein, palm super olein, palm mid-fraction and combinations thereof.

15. The method according to claim 14 comprising:
a) Treating a deodorized vegetable oil with a base in a continuous pipe reactor,
b) Contacting the base treated ingredient of step a) with an adsorbent or an adsorbent and an acid and obtaining the deodorized first, second and/or third ingredient.

16. The triglyceride composition according to claim 1, wherein the first ingredient is palm olein, and the second ingredient is palm stearin.

17. The triglyceride composition according to claim 1, wherein the third ingredient is palm kernel olein.

18. The non-dairy creamer according to claim 6, wherein the sweetening substance is selected from the group consisting of acesulfame potassium, alitame, aspartame, cyclamate, saccharin, sucralose, thaumatin, neotame, sucrose, fructose, isomalt, lactitol, mannitol, maltitol, xylitol, sorbitol, steviol glycoside and combinations thereof.
